(19) United States
(12) Patent Application Publication
(10) Pub. No.: US 2025/0159433 A1
(43) Pub. Date: May 15, 2025

(54) METHOD AND DEVICE FOR REPORTING POSITION INFORMATION

(71) Applicant: Beijing Xiaomi Mobile Software Co., Ltd., Beijing (CN)

(72) Inventor: Xiaowei JIANG, Beijing (CN)

(21) Appl. No.: 18/835,669

(22) PCT Filed: Feb. 10, 2022
(86) PCT No.: PCT/CN2022/075937

§ 371 Date: Aug. 2, 2024

(51) Int. Cl. H04W 4/02; H04W 76/38

(52) U.S. Cl. CPC H04W 4/025; H04W 76/38

(57) ABSTRACT

A method for reporting position information, performed by a terminal device, including: determining that a timing advance (TA) variation value corresponding to the terminal device is greater than a threshold value, where the TA variation value is caused by a change in a position of the terminal device; and reporting position information of the terminal device to a network device.

### CROSS-REFERENCE TO RELATED APPLICATIONS

The present application is a U.S. National Stage of International Application No. PCT/CN2022/075937, filed on Feb. 10, 2022, the contents of all of which are incorporated herein by reference in their entirety for all purposes.

### BACKGROUND OF THE INVENTION

As Internet of Things applications advance, terminal position information is being increasingly applied to complex “Internet of Everything” scenarios.

### SUMMARY OF THE INVENTION

The present disclosure relates to the field of communication technology, in particular to a method and device for reporting position information.

A method and device for reporting position information are provided according to embodiments of the present disclosure.

In a first aspect, a method for reporting position information is provided according to an embodiment of the present disclosure. The method is performed by a terminal device and includes:
determining that a timing advance (TA) variation value corresponding to the terminal device is greater than a threshold value, where the TA variation is caused by a change in a position of the terminal device; and
reporting position information of the terminal device to a network device.

In a second aspect, a method for reporting position information is provided according to another embodiment of the present disclosure. The method is performed by a network device and includes: receiving position information of a terminal device reported by the terminal device, where the position information is sent by the terminal device in a case where the terminal device determines that a timing advance (TA) variation value caused by a change in a position of the terminal device is greater than a threshold value.

In a third aspect, a communication device is provided according to an embodiment of the present disclosure. The communication device includes one or more processors and a memory that stores a computer program, where the one or more processors are configured to execute the computer program stored on the memory to cause the communication device to perform the method according to the first aspect.

In a fourth aspect, a communication device is provided according to an embodiment of the present disclosure. The communication device includes one or more processors and a memory that stores a computer program, where the one or more processors are configured to execute the computer program stored on the memory to cause the communication device to perform the method according to the second aspect.

In a fifth aspect, a non-transitory computer-readable storage medium is provided according to an embodiment of the present disclosure. The non-transitory-computer-readable storage medium is configured to store instructions used for the above terminal device, where the instructions, when executed, cause the terminal device to perform the above method in the first aspect.

In a sixth aspect, a non-transitory computer-readable storage medium is provided according to an embodiment of the present disclosure. The non-transitory computer-readable storage medium is configured to store instructions used for the above network device, where the instructions, when executed, cause the network device to perform the above method in the second aspect.

### BRIEF DESCRIPTION OF DRAWINGS

In order to more clearly illustrate technical solutions in the embodiments of the present disclosure or the related art, accompanying drawings used by the embodiments of the present disclosure or the related art are described below.

FIG. 1 is a schematic architectural diagram of a communication system according to an embodiment of the present disclosure.

FIG. 2 is a schematic flowchart of a method for reporting position information according to an embodiment of the present disclosure.

FIG. 3 is a schematic flowchart of a method for reporting position information according to another embodiment of the present disclosure.

FIG. 4 is a schematic flowchart of a method for reporting position information according to yet another embodiment of the present disclosure.

FIG. 5 is a schematic flowchart of a method for reporting position information according to yet another embodiment of the present disclosure.

FIG. 6 is a schematic flowchart of a method for reporting position information according to yet another embodiment of the present disclosure.

FIG. 7 is a schematic flowchart of a method for reporting position information according to yet another embodiment of the present disclosure.

FIG. 8 is a schematic flowchart of a method for reporting position information according to yet another embodiment of the present disclosure.

FIG. 9 is a schematic flowchart of a method for reporting position information according to yet another embodiment of the present disclosure.

FIG. 10 is a schematic structural diagram of a communication device according to an embodiment of the present disclosure.

FIG. 11 is a schematic structural diagram of a communication device according to another embodiment of the present disclosure.

FIG. 12 is a schematic structural diagram of a chip according to an embodiment of the present disclosure.

### DETAILED DESCRIPTION OF THE INVENTION

The embodiments will be described in detail here, and their examples are indicated in the accompanying drawings. Unless otherwise indicated, when the following description refers to the accompanying drawings, the same number in the different accompanying drawings represents the same or similar elements. Embodiments described in the following examples do not represent all embodiments consistent with the present disclosure. Rather, they are merely examples of a device and method consistent with some aspects of the present disclosure as detailed in the appended claims.

Terms used in the present disclosure are explained firstly for better understanding.

### 1. Non-Terrestrial Networks (NTN)

Non-terrestrial networks are formed by integrating satellite communication systems with 5G technology, combining their respective strengths to form a globally seamless, integrated communication network that covers land, sea, air, and space. These networks can meet ubiquitous and diverse service requirements of users, which are a significant direction for future communication development.

### 2. Timing Advance (TA)

Signals experience delays during transmission in space. For example, in a case where a terminal device moves away from a base station during a call, the signal sent from the base station arrives at the terminal device with increasing delay. Simultaneously, the signal from the terminal device also arrives at the base station with increasing delay. Excessive delay can cause the signal from one terminal device in the current time slot to overlap with the signal from another terminal device in the next time slot, resulting in the inter-code interference. Therefore, during data transmission, the uplink transmission from the terminal device needs to have a certain timing advance to ensure that the time intervals between uplink transmissions from different users arriving at the base station are less than a predefined threshold. The base station can send a timing advance command on the downlink channel to the terminal device, indicating the time by which the terminal device should advance its transmission, which is referred to as the timing advance.

In the related art, in a satellite communication network, position information reporting may be triggered according to a timing advance (TA) compensation value T_{TA} corresponding to a terminal device or a variation of specific timing advance (TA) of the terminal device. The specific TA of the terminal device is the TA between the terminal device and a satellite, namely, service link timing advance (TA), which is equal to common pre-compensation T_{TA}—common TA. However, this method of triggering position information reporting suffers from excessive frequency, leading to resource wastage.

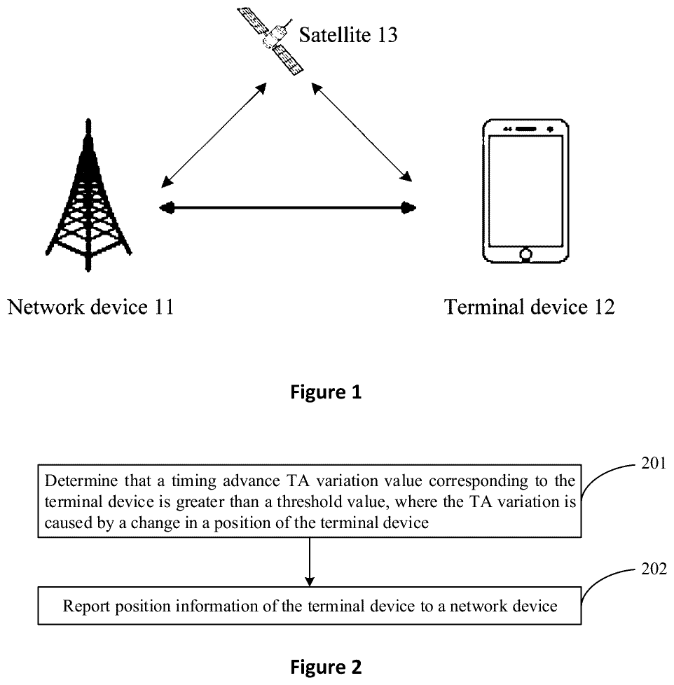

Reference is made to FIG. 1. FIG. 1 is a schematic architectural diagram of a communication system according to an embodiment of the present disclosure. The communication system may include, but is not limited to, one network device and one terminal device. The number and form of devices shown in FIG. 1 are merely an example and do not constitute a limitation on the embodiments of the present disclosure, and two or more than two network devices and two or more than two terminal devices may be included in practical application. As an example, the communication system shown in FIG. 1 includes one network device 11, one terminal device 12 and one satellite 13.

It should be noted that the technical solutions of the embodiments of the present disclosure may be applied to various communication systems. For example, there are a long term evolution (LTE) system, a 5th generation (5G) mobile communication system, a 5G new radio (NR) system, other future new mobile communication systems, or the like.

The network device 11 in the embodiment of the present disclosure is an entity on a network side for transmitting or receiving a signal. For example, the network device 11 may be an evolved NodeB (eNB), a transmission reception point (TRP), a next generation NodeB (gNB) in an NR system, a base station in other future mobile communication system, an access node in a wireless fidelity (WiFi) system, or the like. The specific technology and specific device form used by the network device are not limited in the embodiment of the present disclosure. The network device provided by the embodiment of the present disclosure may be composed of a central unit (CU) and a distributed unit (DU). The CU may also be referred to as a control unit. A CU-DU structure may split protocol layers of the network device such as a base station, functions of some protocol layers are under centralized control in the CU, and functions of some or all of the rest of protocol layers are distributed in the DU which is under centralized control by the CU.

The terminal device 12 in the embodiment of the present disclosure is an entity, for example, a mobile phone, on a user side for receiving or transmitting a signal. The terminal device may also be referred to as a terminal, a user equipment (UE), a mobile station (MS), a mobile terminal (MT), or the like. The terminal device may be an automobile, a smart car, a mobile phone, a wearable device and a pad with a communication function, a computer with a wireless transceiving function, a virtual reality (VR) terminal device, an augmented reality (AR) terminal device, a wireless terminal device in industrial control, a wireless terminal device in self-driving, a wireless terminal device in a remote medical surgery, a wireless terminal device in a smart grid, a wireless terminal device in transportation safety, a wireless terminal device in a smart city, a wireless terminal device in a smart home, or the like. The specific technology and specific device form used by the network device are not limited in the embodiment of the present disclosure.

It may be understood that the communication system described in the embodiment of the present disclosure is intended to illustrate the technical solution of the embodiment of the present disclosure more clearly and does not constitute a limitation on the technical solution provided by the embodiment of the present disclosure. Those ordinarily skilled in the art may know that with evolution of a system architecture and emergence of a new service scene, the technical solution provided by the embodiment of the present disclosure is also applicable to similar technical problems.

In general, reporting the position information is triggered when a variation in a timing advance (TA) compensation value T_{TA} corresponding to the terminal device or a variation in TA of a service link of the terminal device exceeds a certain threshold value. Either a terminal device or a satellite moves may cause a TA variation, triggering the position information reporting. This contradicts the original intention of introducing TA reporting based on the position information of the terminal device. The reason for implementing position information reporting is that the network can calculate the round-trip time (RTT) between the terminal device and the satellite using the position information of the terminal device. Then the uplink scheduling can be performed based on the RTT, eliminating the need for frequent TA reporting by the terminal device. Therefore, it is necessary to modify the trigger conditions to exclude the factor of satellite movement. The following detailed description, along with the accompanying drawings, provides a method and device for reporting position information provided by the present disclosure.

Reference is made to FIG. 2. FIG. 2 is a schematic flowchart of a method for reporting position information according to an embodiment of the present disclosure. The method is performed by a terminal device. As shown in FIG. 2, the method may include but is not limited to steps as follows.

Step 201: it is determined that a timing advance (TA) variation value corresponding to a terminal device is greater than a threshold value, where the TA variation is caused by a change in the position of the terminal device.

In the present disclosure, due to a large coverage of the satellite in an NTN network, the network device needs to know the position information of the terminal device to select an appropriate access and mobility management function (AMF) for the terminal device. Hence, the terminal device is required to report its position information when meeting a triggering condition or periodically. Since either the movement of the terminal device or the movement of the satellite may cause the terminal device to meet the triggering condition for reporting the position information, it can lead to a waste of resources. To avoid the case where the terminal device has not moved but the position information reporting is triggered merely due to satellite movement causing the TA variation value to exceed the threshold value, in the present disclosure, only the TA variation value caused by the position change of the terminal device is retained while eliminating the impact of the satellite movement on the TA variation value. The position information of the terminal device is reported to the network device in a case where the timing advance TA variation value corresponding to terminal device caused by the position change of the terminal device is greater than the threshold value.

In the present disclosure, after obtaining position information, the terminal device may determine the TA variation value according to current position information or last reported position information, and current satellite position information or a corresponding satellite position when position information was last reported. Subsequently, the terminal device may compare the TA variation value with a preset threshold value.

Step 202: the position information of the terminal device is reported to the network device.

In the present disclosure, it may be determined that a change in the position of the terminal device and a condition for reporting the position information is met in a case where the TA variation value corresponding to the terminal device is greater than the threshold value. In this case, the terminal device may report the position information of the terminal device to the network device. Accordingly, the network device may calculate the RTT between the terminal device and the satellite according to the position information reported by the terminal device.

Optionally, the action of reporting the position information to the network device is not triggered in a case where it is determined that the current TA variation value is less than or equal to the threshold value.

Optionally, the terminal device may report the position information only when there is available position information, where the position information may be commonLocationInfo, bt-LocationInfo, wlan-LocationInfo, sensor-LocationInfo, etc.

Optionally, in a case where the network device indicates configuration information for reporting the position information via a connection reconfiguration message, the terminal device may configure the position information in a test report corresponding to reportconfig IE of the configuration information. Hence, the network device may determine the position information of the terminal device according to the test report.

In the present disclosure, once it is determined that the TA variation value corresponding to the terminal device caused by the change in the position of the terminal device is greater than the threshold value, the terminal device reports the position information of the terminal device to the network device. In this way, the terminal device reports the position information only when the TA variation value is greater than the threshold value due to its own position change, thereby eliminating position information reporting triggered by satellite movement and effectively avoiding resource waste.

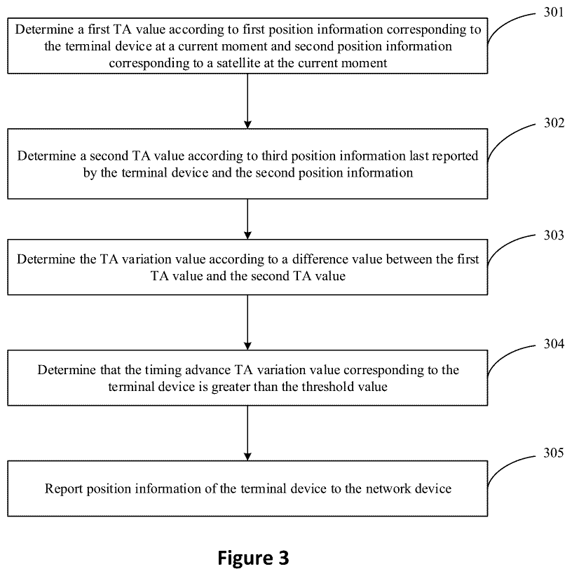

Reference is made to FIG. 3. FIG. 3 is a method for reporting position information according to an embodiment of the present disclosure. The method is performed by the terminal device. As shown in FIG. 3, the method may include but is not limited to steps as follows.

Step 301: a first TA value is determined according to first position information corresponding to the terminal device at a current moment and second position information corresponding to a satellite at the current moment.

In this case, the first position information indicates the information about the position where the terminal device is currently located, and the second position information indicates the information about the position where the satellite is currently located. Since the first TA value is determined according to the position of the terminal device and the position of the satellite, the first TA value is a TA value corresponding to a service link, i.e., a specific timing advance (TA) value of the terminal device.

In the present disclosure, the terminal device may determine the second position information corresponding to the satellite at the current moment according to an ephemeris corresponding to the satellite, or may also determine the second position information according to indications of other terminal device or network device, which is not limited in the present disclosure.

Step 302: a second TA value is determined according to third position information last reported by the terminal device and the second position information.

In the present disclosure, the terminal device may record the position information of the corresponding terminal device and the position information of the satellite when the position information is reported. The terminal device then may calculate the second TA value at the current moment according to the recorded third position information of the terminal device from the last report and the second position information of the satellite at the current moment.

Step 303: a TA variation value is determined according to a difference value between the first TA value and the second TA value.

In the present disclosure, a difference between the first TA value and the second TA value may be calculated and then may be determined as the TA variation value corresponding to the terminal device.

Step 304: it is determined that the TA variation value corresponding to the terminal device is greater than a threshold value.

Step 305: the position information of the terminal device is reported to the network device.

In the present disclosure, the specific implementation processes of step 304 to step 305 may refer to detailed description in any embodiments of the present disclosure, which will not be repeated here.

It can be understood that since the TA value corresponding to the service link represents the distance between the terminal device and the satellite, in the present disclosure, two TA values for the service link are determined based on the current second position information of the satellite and the position information of the terminal device before and after its movement. The TA variation value is then determined. Since this TA variation value is determined based on the same position information of the satellite—meaning the position change of the satellite is not considered—it ensures that only the position change of the terminal device is considered when determining whether the condition for reporting the position information is met, without accounting for the position change of the satellite. This effectively avoids resource wastage caused by the position information reporting triggered solely by changes in the position of the satellite, while the position of the terminal device remains unchanged.

In the present disclosure, the terminal device may determine the first TA value according to the first position information corresponding to the terminal device at the current moment and the second position information corresponding to the satellite at the current moment, determine the second TA value according to the third position information last reported by the terminal device and the second position information, then determine the TA variation value according to the difference value between the first TA value and the second TA value. Further, the terminal device may report the position information of the terminal device to the network device in a case where the TA variation value corresponding to the terminal device is greater than the threshold value. Thus, the TA variation value may be determined based on the current position information of the satellite and the position information of the terminal device before and after its movement. In this way, part of the TA variation value caused by the satellite movement is effectively eliminated, preventing position information reporting from being triggered solely by the satellite movement and thereby avoiding resource waste.

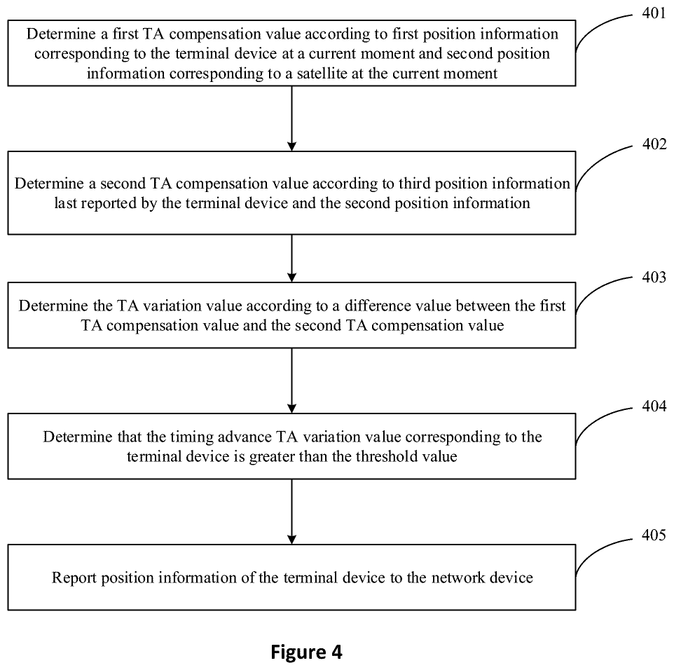

Reference is made to FIG. 4. FIG. 4 is a method for reporting position information according to an embodiment of the present disclosure. The method is performed by the terminal device. As shown in FIG. 4, the method may include but is not limited to steps as follows.

Step 401: a first TA compensation value is determined according to the first position information corresponding to the terminal device at a current moment and the second position information corresponding to the satellite at the current moment.

In the present disclosure, during a random access process, after a terminal sends a preamble at a random access channel (RACH) occasion, a network needs to know the corresponding sending occasion upon receiving the preamble, so that the network correctly addresses a random access request in a random access response and performs uplink timing adjustment. However, in satellite communication systems, the RTT difference between different terminals and the base station can be up to 10.3 ms. When the interval between occasions is less than the maximum RTT difference, there can be an overlap in the preamble reception windows for different occasions, making it difficult for the base station to infer the occasion subframe and the uplink timing deviation sent by the terminal from the received preamble. To address this issue of preamble reception ambiguity, TA pre-compensation may be used. In other words, before sending the preamble, the terminal device advances its uplink (UL) timing based on the RTT between the terminal and the base station. In this way, it ensures that all the time differences of preambles sent by different terminal devices using the same occasion are limited within one subframe when they arrive at the base station.

In the present disclosure, the terminal device may determine the second position information corresponding to the satellite at the current moment according to an ephemeris corresponding to the satellite, or may also determine the second position information according to indications from other terminal devices or network device, which is not limited in the present disclosure.

In the present disclosure, the terminal device may determine the position information of a current service satellite while obtaining the current position information. The terminal device may determine the current position information of the terminal device as the first position information and determine the current position information of the satellite as the second position information. The terminal device may then calculate the first TA compensation value T_{TA} according to the first position information corresponding to the terminal device at the current moment and the second position information corresponding to the satellite at the current moment.

In general, T_{TA} may be equated to the RTT between the terminal device and the satellite plus common TA, where common TA is the RTT of the link from the satellite to the network device.

Step 402: a second TA compensation value is determined according to third position information which was last reported by the terminal device and the second position information.

In the present disclosure, the terminal device may record the position information of the corresponding terminal device and the position information of the satellite when reporting the position information. The terminal device may then calculate the second TA compensation value at the current moment according to the recorded third position information of the terminal device from the last report and the second position information of the satellite at the current moment.

Step 403: the TA variation value is determined according to a difference value between the first TA compensation value and the second TA compensation value.

In the present disclosure, a difference between the first TA compensation value and the second TA compensation value may be calculated and then may be determined as the TA variation value corresponding to the terminal device.

Step 404: it is determined that the TA variation value corresponding to the terminal device is greater than the threshold value.

Step 405: the position information of the terminal device is reported to the network device.

In the present disclosure, the specific implementation processes of step 404 to step 405 may refer to detailed description in any embodiment of the present disclosure, which will not be repeated here.

It can be understood that since the TA compensation value T_{TA} may represent a distance between the terminal device and the satellite, in the present disclosure, two TA compensation values are determined based on the current second position information of the satellite and the position information of the terminal device before and after its movement. The TA variation value is then determined. Since this TA variation value is determined based on the same position information of the satellite—meaning the position change of the satellite is not considered—it ensures that only the position change of the terminal device is considered when determining whether the condition for reporting the position information is met, without accounting for the position change of the satellite. This effectively avoids resource wastage caused by the position information reporting triggered solely by changes in the position of the satellite, while the position of the terminal device remains unchanged.

In the present disclosure, the terminal device may determine the first TA compensation value according to the first position information corresponding to the terminal device at the current moment and the second position information corresponding to the satellite at the current moment, determine the second TA compensation value according to the third position information last reported by the terminal device and the second position information. Then the terminal device may determine the TA variation value according to the difference value between the first TA compensation value and the second TA compensation value. Further, the terminal device may report the position information of the terminal device to the network device in a case where the TA variation value corresponding to the terminal device is greater than the threshold value. Thus, the TA variation value may be determined based on the current position information of the satellite and the position information of the terminal device before and after its movement. In this way, part of the TA variation value caused by satellite movement is effectively eliminated, preventing position information reporting from being triggered solely by satellite movement and thereby avoiding resource waste.

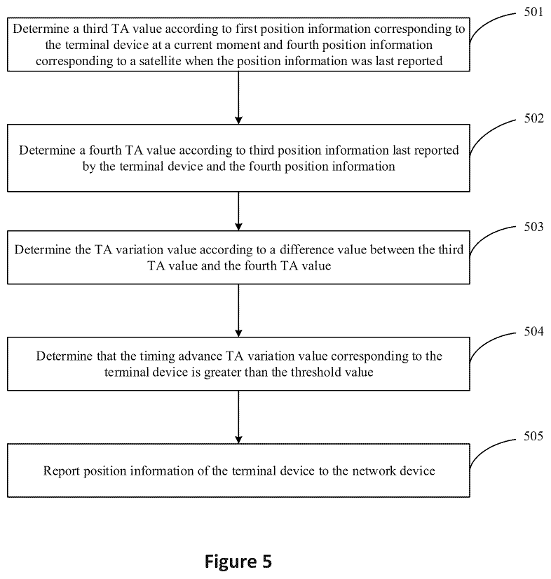

Reference is made to FIG. 5. FIG. 5 is a method for reporting position information according to an embodiment of the present disclosure. The method is performed by the terminal device. As shown in FIG. 5, the method may include but is not limited to steps as follows.

Step 501: a third TA value is determined according to the first position information corresponding to the terminal device at the current moment and the fourth position information corresponding to the satellite when position information was last reported.

Since the first TA value is determined according to the position of the terminal device and the position of the satellite, the first TA value is a TA value corresponding to a service link, i.e., a specific timing advance (TA) value of the terminal device.

In the present disclosure, the terminal device may determine the position information corresponding to the satellite at the current moment according to an ephemeris corresponding to the satellite, or may also determine the position information according to indications from other terminal devices or network device, which is not limited in the present disclosure.

In the present disclosure, the terminal device may record the position information of the corresponding terminal device and the position information of the satellite when the position information is reported, and then may calculate the third TA value at the current moment according to the recorded fourth position information of the corresponding satellite when the position information was last reported and the first position information corresponding to the terminal device at the current moment.

Step 502: a fourth TA value is determined according to the third position information last reported by the terminal device and the fourth position information.

In the present disclosure, the terminal device may calculate the fourth TA value at the current moment according to the recorded third position information of the terminal device and the fourth position information of the satellite from the last report.

Step 503: the TA variation value is determined according to a difference value between the third TA value and the fourth TA value.

In the present disclosure, a difference between the third TA value and the fourth TA value may be calculated and then may be determined as the TA variation value corresponding to the terminal device.

Step 504: it is determined that the TA variation value corresponding to the terminal device is greater than the threshold value.

Step 505: the position information of the terminal device is reported to the network device.

In the present disclosure, the specific implementation processes of step 504 to step 505 may refer to detailed description in any one of embodiments of the present disclosure, which will not be repeated here.

It can be understood that since the TA value corresponding to a service link may represent a distance between the terminal device and the satellite, in the present disclosure, two TA values corresponding to the service link are determined based on the fourth position information of the corresponding satellite when the position information was last reported and the position information of the terminal device before and after its movement. The TA variation value is the determined. Since this TA variation value is determined based on the same position information of the satellite—meaning the position change of the satellite is not considered—it ensures that only the position change of the terminal device is considered when determining whether the condition for reporting the position information is met, without accounting for the position change of the satellite. This effectively avoids resource wastage caused by the position information reporting triggered solely by changes in the position of the satellite, while the position of the terminal device remains unchanged.

In the present disclosure, the terminal device may determine the third TA value according to the first position information corresponding to the terminal device at the current moment and the fourth position information corresponding to the satellite when the position information was last reported, determine the fourth TA value according to the third position information last reported by the terminal device and the fourth position information, and then determine the TA variation value according to the difference value between the third TA value and the fourth TA value. Further, the terminal device may report the position information of the terminal device to the network device in a case where the TA variation value corresponding to the terminal device is greater than the threshold value. Thus, the TA variation value may be determined based on the fourth position information corresponding to the satellite when the position information was last reported and the position information of the terminal device before and after its movement. In this way, part of the TA variation value caused by satellite movement is effectively eliminated, preventing position information reporting from being triggered solely by satellite movement and thereby avoiding resource waste.

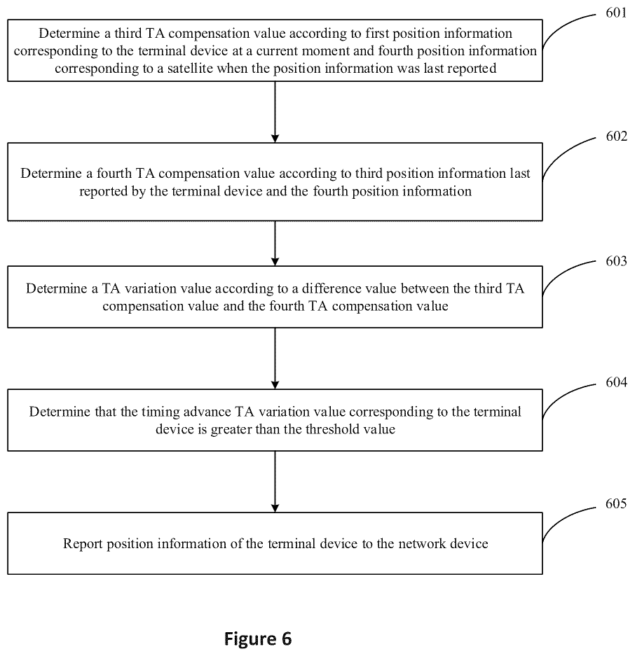

Reference is made to FIG. 6. FIG. 6 is a method for reporting position information according to an embodiment of the present disclosure. The method is performed by the terminal device. As shown in FIG. 6, the method may include but is not limited to steps as follows.

Step 601: a third TA compensation value is determined according to the first position information corresponding to the terminal device at the current moment and the fourth position information corresponding to the satellite when the position information was last reported.

In the present disclosure, during a random access process, after a terminal sends a preamble at a RACH occasion, a network needs to know the corresponding sending occasion upon receiving the preamble, so that the network correctly addresses a random access request in a random access response and performs uplink timing adjustment. However, in a satellite communication system, the RTT difference between different terminals and the base station can be up to 10.3 ms. When the interval between occasions is less than the maximum RTT difference, there can be an overlap in the preamble reception windows for different occasions, making it difficult for the base station to infer the occasion subframe and the uplink timing deviation sent by the terminal from the received preamble. To address this issue of preamble reception ambiguity, TA pre-compensation may be used. In other words, before sending the preamble, the terminal device advances its uplink (UL) timing based on the RTT between the terminal and the base station. In this way, it ensures that all the time differences of preambles sent by different terminal devices using the same occasion are limited within one subframe when they arrive at the base station.

In the present disclosure, the terminal device may determine the position information corresponding to the satellite at the current moment according to the ephemeris corresponding to the satellite, or may also determine the position information according to indications from other terminal devices or network device, which is not limited in the present disclosure.

In the present disclosure, the terminal device may record the corresponding position information of the terminal device and the corresponding position information of the satellite when the position information is reported, and then may calculate the third TA compensation value T_{TA} at the current moment according to the recorded corresponding fourth position information of the satellite when the position information was last reported and the first position information corresponding to the terminal device at the current moment.

In general, T_{TA} may be equated to the RTT between the terminal device and the satellite plus common TA, where common TA is the RTT of the link from the satellite to the network device.

Step 602: a fourth TA compensation value is determined according to the third position information last reported by the terminal device and the fourth position information.

In the present disclosure, the terminal device may calculate the fourth TA compensation value at the current moment according to the recorded third position information of the terminal device from the last reported and the fourth position information.

Step 603: the TA variation value is determined according to a difference value between the third TA compensation value and the fourth TA compensation value.

In the present disclosure, a difference between the third TA compensation value and the fourth TA compensation value may be calculated and then may be determined as the TA variation value corresponding to the terminal device.

Step 604: it is determined that the TA variation value corresponding to the terminal device is greater than the threshold value.

Step 605: the position information of the terminal device is reported to the network device.

In the present disclosure, the specific implementation processes of step 604 to step 605 may refer to detailed description in any embodiment of the present disclosure, which will not be repeated here.

It can be understood that the TA compensation value T_{TA} may represent a distance between the terminal device and the satellite, in the present disclosure, two TA compensation values are determined based on the fourth position information of the corresponding satellite when the position information was last reported and the position information of the terminal device before and after its movement. Then the TA variation value is determined. Since this TA variation value is determined based on the same position information of the satellite—meaning the position change of the satellite is not considered—it ensures that only the position change of the terminal device is considered when determining whether the condition for reporting the position information is met, without accounting for the position change of the satellite. This effectively avoids resource wastage caused by the position information reporting triggered solely by changes in the position of the satellite, while the position of the terminal device remains unchanged.

In the present disclosure, the terminal device may determine the third TA compensation value according to the first position information corresponding to the terminal device at the current moment and the fourth position information corresponding to the satellite when the position information was last reported, determine the fourth TA compensation value according to the third position information last reported by the terminal device and the fourth position information, and then determine the TA variation value according to the difference value between the third TA compensation value and the fourth TA compensation value. Further, the terminal device may report the position information of the terminal device to the network device in a case where the TA variation value corresponding to the terminal device is greater than the threshold value. Thus, the TA variation value may be determined based on the fourth position information corresponding to the satellite when the position information was last reported and the position information of the terminal device before and after its movement. In this way, part of the TA variation value caused by satellite movement is effectively eliminated, preventing position information reporting from being triggered solely by satellite movement and thereby avoiding resource waste.

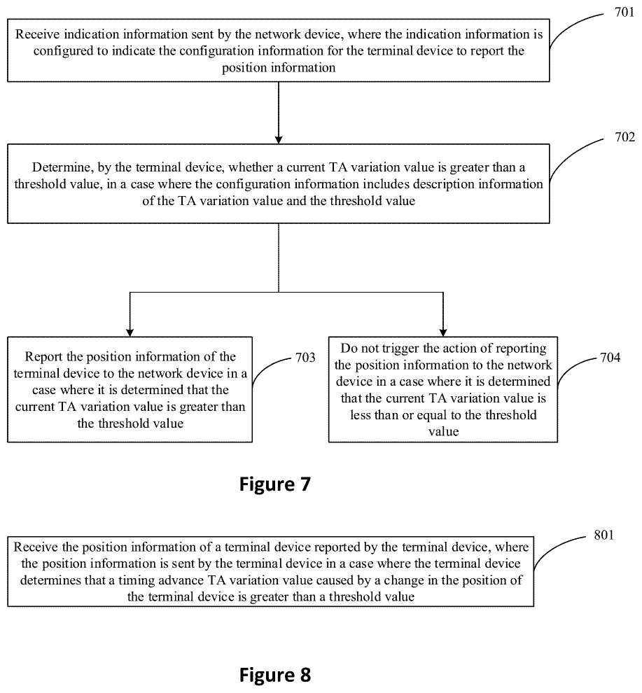

Reference is made to FIG. 7. FIG. 7 is a method for reporting position information according to an embodiment of the present disclosure. The method is performed by the terminal device. As shown in FIG. 7, the method may include but is not limited to steps as follows.

Step 701: indication information sent by the network device is received, where the indication information is configured to indicate configuration information for the terminal device to report the position information.

The configuration information may include any one of the following: description information of the TA variation value; a periodic value of reporting the position information; and TA reporting configuration information based on a media access control control element (MAC CE).

In the present disclosure, the description information of the TA variation value may be used to describe the specific meaning of the TA variation value. The terminal device may determine how to determine the TA variation value triggered the position information reporting from the description information of the TA variation value. It should be understood that the TA variation value determined according to the description information of the TA variation value merely considers the TA change caused by the position change of the terminal device. In other words, the approach for determining the TA variation value according to the description information of the TA variation value may be the approach according to any embodiment of the present disclosure, which will not be repeated here.

Optionally, in a case where the configuration information includes the description information of the TA variation value, the configuration information may further include the threshold value. In this way, the terminal device may trigger the position information reporting in a case where the TA variation value is greater than the threshold value according to the description information of the TA variation value.

Optionally, in a case where the configuration information for reporting the position information indicated by the network device includes the periodic value of reporting the position information, the terminal device may report the position information periodically according to the periodic value.

Optionally, in a case where the configuration information for reporting the position information indicated by the network device includes the TA reporting configuration information based on the MAC CE, the terminal device may report the position information according to the TA reporting configuration information based on the MAC CE.

Optionally, the network device may configure the configuration information for reporting the position information in a connection reconfiguration message. The configuration information may include a reportconfig information element (IE), and the description information of the TA variation value is configured in EventTriggerConfig IE in the reportconfig IE.

Optionally, the configuration information may further include a hysteresis parameter, timeToTrigger and the like. In this case, the terminal device may trigger the position information reporting according to the indicated hysteresis parameter or timeToTrigger.

Step 702: the terminal device determines whether a current TA variation value is greater than a threshold value in a case where the configuration information includes the description information of the TA variation value and the threshold value.

Step 703: the position information of the terminal device is reported to the network device in a case where it is determined that the current TA variation value is greater than the threshold value.

Step 704: the action of reporting the position information to the network device is not triggered in a case where it is determined that the current TA variation value is less than or equal to the threshold value.

In the present disclosure, the specific implementation processes of step 703 to step 704 may refer to detailed description in any embodiment of the present disclosure, which will not be repeated here.

In the present disclosure, after receiving the indication information used to indicate configuration information for the terminal device to report the position information, sent by the network device, the terminal device may report the position information of the terminal device to the network device in a case where the TA variation value corresponding to the terminal device is greater than the threshold value. By determining the TA variation value merely according to the position change of the terminal device, part of the TA variation value caused by the satellite movement is eliminated, preventing position information reporting from being triggered solely by the satellite movement and thereby avoiding resource waste.

Reference is made to FIG. 8. FIG. 8 is a method for reporting position information according to an embodiment of the present disclosure. The method is performed by a network device. As shown in FIG. 8, the method may include but is not limited to steps as follows.

Step 801: position information of a terminal device sent by the terminal device is received, where the position information is sent by the terminal device in a case where the terminal device determines that a timing advance (TA) variation value caused by a change in a position of the terminal device is greater than a threshold value.

In the present disclosure, due to a large coverage of the satellite in an NTN network, the network device needs to know the position information of the terminal device to select an appropriate access and mobility management function (AMF) for the terminal device. Hence, the terminal device is required to report its position information when meeting a triggering condition or periodically. Since either the movement of the terminal device or the movement of the satellite may cause the terminal device to meet the triggering condition for reporting the position information, it can lead to a waste of resources. To avoid the case where the terminal device has not moved but the position information reporting is triggered merely due to the satellite movement causing the TA variation value to exceed the threshold value, in the present disclosure, only the TA variation value caused by the position change of the terminal device is retained while eliminating the impact of the satellite movement on the TA variation value. The position information of the terminal device is reported to the network device in a case where the TA variation value corresponding to terminal device caused by the position change of the terminal device is greater than the threshold value.

In the present disclosure, after obtaining the position information, the terminal device may determine the TA variation value according to current position information or last reported position information, and current satellite position information or a corresponding satellite position when position information was last reported. The terminal device may then compare the TA variation value with a preset threshold value. It may be determined that the position of the terminal device is changed and the condition for reporting the position information is met, in a case where the TA variation value corresponding to the terminal device is greater than the threshold value. At this moment, the terminal device may report the position information of the terminal device to the network device. Accordingly, the network device may calculate the RTT between the terminal device and the satellite according to the position information reported by the terminal device.

Optionally, the action of reporting the position information to the network device is not triggered in a case where the current TA variation value is less than or equal to the threshold value.

Optionally, the terminal device may report the position information only when there is available position information, where the position information may be commonLocationInfo, bt-LocationInfo, wlan-LocationInfo, sensor-LocationInfo, etc.

Optionally, when the network device indicates configuration information for reporting the position information through a connection reconfiguration message, the terminal device may configure the position information in a test report corresponding to reportconfig IE of the configuration information. In this way, the network device may determine the position information of the terminal device according to the test report.

In the present disclosure, the network device may receive the position information of the terminal device sent by the terminal device under the condition that the terminal device determines the timing advance (TA) variation value caused by the position change of the terminal device to be greater than the threshold value. Hence, the terminal device reports the position information merely under the condition that the TA variation value caused by the position change of the terminal device is greater than the threshold value, so that the phenomenon of triggering reporting of the position information due to satellite movement is avoided, and the waste of resources is effectively avoided.

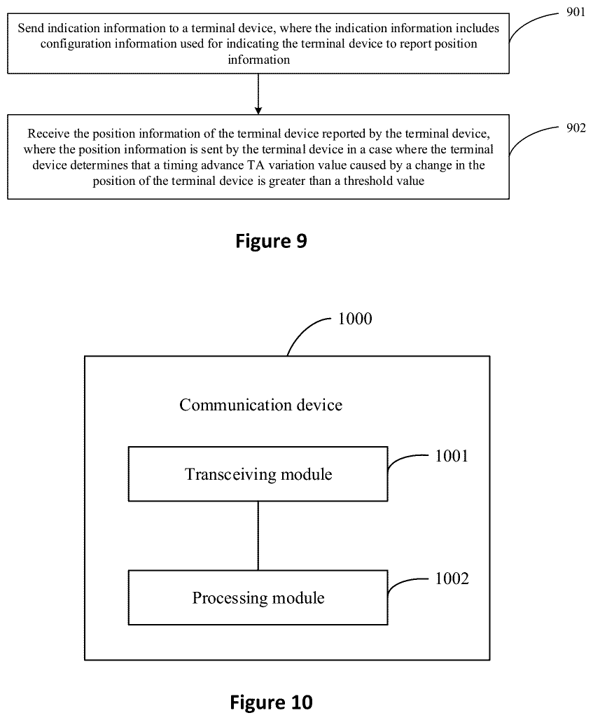

Reference is made to FIG. 9. FIG. 9 is a method for reporting position information according to an embodiment of the present disclosure. The method is performed by the network device. As shown in FIG. 9, the method may include but is not limited to steps as follows.

Step 901: indication information is sent to the terminal device, where the indication information is configured to indicate configuration information for the terminal device to report the position information.

The configuration information may include any one of the following: description information of the TA variation value; a periodic value of reporting the position information; and TA reporting configuration information based on a media access control control element (MAC CE).

In the present disclosure, the description information of the TA variation value may be used to describe the specific meaning of the TA variation value. The terminal device may determine how to determine the TA variation value triggered the position information reporting from the description information of the TA variation value. It should be understood that the TA variation value determined according to the description information of the TA variation value merely considers the TA change caused by the position change of the terminal device. In other words, the approach for determining the TA variation value according to the description information of the TA variation value may be the approach according to any embodiment of the present disclosure, which will not be repeated here.

Optionally, the description information of the TA variation value may include: determining a first TA value according to the first position information corresponding to the terminal device at the current moment and the second position information corresponding to the satellite at the current moment; determining a second TA value according to the third position information last reported by the terminal device and the second position information; and determining the TA variation value from a difference value between the first TA value and the second TA value.

Optionally, the description information of the TA variation value may include: determining a first TA compensation value according to the first position information corresponding to the terminal device at the current moment and the second position information corresponding to the satellite at the current moment; determining a second TA compensation value according to the third position information last reported by the terminal device and the second position information; and determining the TA variation value according to a difference value between the first TA compensation value and the second TA compensation value.

Optionally, the description information of the TA variation value may include: determining a third TA value according to the first position information corresponding to the terminal device at the current moment and the fourth position information corresponding to the satellite when the position information was last; determining a fourth TA value according to the third position information last reported by the terminal device and the fourth position information; and determining the TA variation value according to a difference value between the third TA value and the fourth TA value.

Optionally, the description information of the TA variation value may include: determining a third TA compensation value according to the first position information corresponding to the terminal device currently and the fourth position information corresponding to the satellite when the position information was last reported; determining a fourth TA compensation value according to the third position information last reported by the terminal device and the fourth position information of the satellite; and determining the TA variation value according to a difference value between the third TA compensation value and the fourth TA compensation value.

Optionally, in a case where the configuration information includes the description information of the TA variation value, the configuration information may further include the threshold value. In this way, the terminal device may trigger the position information reporting in a case where it is determined that the TA variation value is greater than the threshold value according to the description information of the TA variation value.

Optionally, in a case where the configuration information for reporting the position information indicated by the network device includes the periodic value of reporting the position information, the terminal device may report the position information periodically according to the periodic value.

Optionally, in a case where the configuration information for reporting the position information indicated by the network device includes the TA reporting configuration information based on the MAC CE, the terminal device may report the position information according to the TA reporting configuration information based on the MAC CE.

Optionally, the network device may configure the configuration information for reporting the position information in a connection reconfiguration message. The configuration information may include a reportconfig information element (IE), and the description information of the TA variation value is configured in EventTriggerConfig IE in the reportconfig IE.

Optionally, the configuration information may further include a hysteresis parameter, timeToTrigger and the like. In this case, the terminal device may trigger the position information reporting according to the indicated hysteresis parameter or timeToTrigger.

Step 902: the position information of the terminal device reported by the terminal device is received, where the position information is sent by the terminal device in a case where the terminal device determines that the TA variation value caused by the change in the position of the terminal device is greater than the threshold value.

In the present disclosure, the specific implementation process of step 902 may refer to detailed description in any embodiment of the present disclosure, which will not be repeated here.

In the present disclosure, the network device may send to the terminal device the indication information including the configuration information for indicating the terminal device to report the position information. The network device may then receive the position information of the terminal device sent by the terminal device in a case where the terminal device determines that the TA variation value caused by the change in the position of the terminal device is greater than the threshold value. In this way, the terminal device only reports the position information in a case where the TA variation value caused by its own position change is greater than the threshold value, preventing position information reporting from being triggered by the satellite movement and thereby avoiding resource waste.

Reference is made to FIG. 10. FIG. 10 is a schematic structural diagram of a communication device 1000 according to an embodiment of the present disclosure. The communication device 1000 shown in FIG. 10 may include a transceiving module 1001 and a processing module 1002. The transceiving module 1001 may include a transmitting module and/or a receiving module. The transmitting module is configured to implement a transmitting function, while the receiving module is configured to implement a receiving function. And, the transceiving module 1001 may implement the transmitting function and/or the receiving function.

It should be understood that the communication device 1000 may be a terminal device, or a device in the terminal device, or a device capable of matching with the terminal device for use.

The communication device 1000 is on a terminal device side, which includes:
a processing module 1002, configured to determine that a timing advance (TA) variation value corresponding to the terminal device is greater than a threshold value, where the TA variation is caused by a change in a position of the terminal device;
a transceiving module 1001, configured to report position information of the terminal device to a network device.

Optionally, the processing module 1002 is further configured to:
determine a first TA value according to first position information corresponding to the terminal device at a current moment and second position information corresponding to a satellite at the current moment;
determine a second TA value according to third position information last reported by the terminal device and the second position information; and
determine the TA variation value according to a difference value between the first TA value and the second TA value.

Optionally, the processing module 1002 is further configured to:
determine a first TA compensation value according to the first position information corresponding to the terminal device at the current moment and the second position information corresponding to the satellite at the current moment;
determine a second TA compensation value according to the third position information last reported by the terminal device and the second position information; and
determine the TA variation value according to a difference value between the first TA compensation value and the second TA compensation value.

Optionally, the processing module 1002 is further configured to:
determine a third TA value according to the first position information corresponding to the terminal device at the current moment and the fourth position information corresponding to the satellite when position information was last reported;
determine a fourth TA value according to the third position information last reported by the terminal device and the fourth position information; and
determine the TA variation value according to a difference value between the third TA value and the fourth TA value.

Optionally, the processing module 1002 is further configured to:
determine a third TA compensation value according to the first position information corresponding to the terminal device at the current moment and the fourth position information corresponding to the satellite when the position information was last reported;
determine a fourth TA compensation value according to the third position information last reported by the terminal device and the fourth position information; and
determine the TA variation value according to a difference value between the third TA compensation value and the fourth TA compensation value.

Optionally, the transceiving module 1001 is further configured to:
receive indication information sent by the network device, where the indication information is configured to indicate configuration information for the terminal device to report the position information.

Optionally, the configuration information includes any one of the following:
description information of the TA variation value;
a periodic value of reporting the position information; and
TA reporting configuration information based on a media access control control element (MAC CE).

It should be understood that the communication device 1000 may be a network device, or a device in the network device, or a device capable of matching with the network device for use.

The communication device 1000 is on a network device side, which includes:
a transceiving module 1001, configured to receive position information of a terminal device reported by the terminal device, where the position information is sent by the terminal device in a case where the terminal device determines that a timing advance (TA) variation value caused by a change in a position of the terminal device is greater than a threshold value.

Optionally, the transceiving module 1001 is further configured to:
send indication information to the terminal device, where the indication information is configured to indicate configuration information for the terminal device to report the position information.

Optionally, the configuration information includes any one of the following:
description information of the TA variation value;
a periodic value of reporting the position information; and
TA reporting configuration information based on a media access control control element (MAC CE).

Optionally, the description information of the TA variation value includes:
determining a first TA value according to first position information corresponding to the terminal device at the current moment and second position information corresponding to a satellite at the current moment;
determining a second TA value according to third position information last reported by the terminal device and the second position information; and
determining the TA variation value according to a difference value between the first TA value and the second TA value.

Optionally, the description information of the TA variation value includes:
determining a first TA compensation value according to the first position information corresponding to the terminal device at the current moment and the second position information corresponding to the satellite at the current moment;
determining a second TA compensation value according to third position information last reported by the terminal device and the second position information;
determining the TA variation value according to a difference value between the first TA compensation value and the second TA compensation value.

Optionally, the description information of the TA variation value includes:
determining a third TA value according to the first position information corresponding to the terminal device at the current moment and fourth position information corresponding to the satellite when the position information was last reported;
determining a fourth TA value according to the third position information last reported by the terminal device and the fourth position information; and
determining the TA variation value according to a difference value between the third TA value and the fourth TA value.

Optionally, the description information of the TA variation value includes:
determining a third TA compensation value according to the first position information corresponding to the terminal device at the current moment and the fourth position information when the position information was last reported;
determining a fourth TA compensation value according to the third position information last reported by the terminal device and the fourth position information of the satellite; and
determining the TA variation value according to a difference value between the third TA compensation value and the fourth TA compensation value.

It should be noted that explanatory description for the above embodiments of the method for reporting position information is also applicable for the device in this embodiment, which is thus not described in detail here.

In the present disclosure, once it is determined that the timing advance (TA) variation value corresponding to the terminal device caused by the position change of the terminal device is greater than the threshold value, the terminal device reports the position information of the terminal device to the network device. In this way, the terminal device reports the position information only in a case where the TA variation value caused by the position change of the terminal device is greater than the threshold value, preventing position information reporting from being triggered by the satellite movement and thereby avoiding resource waste.

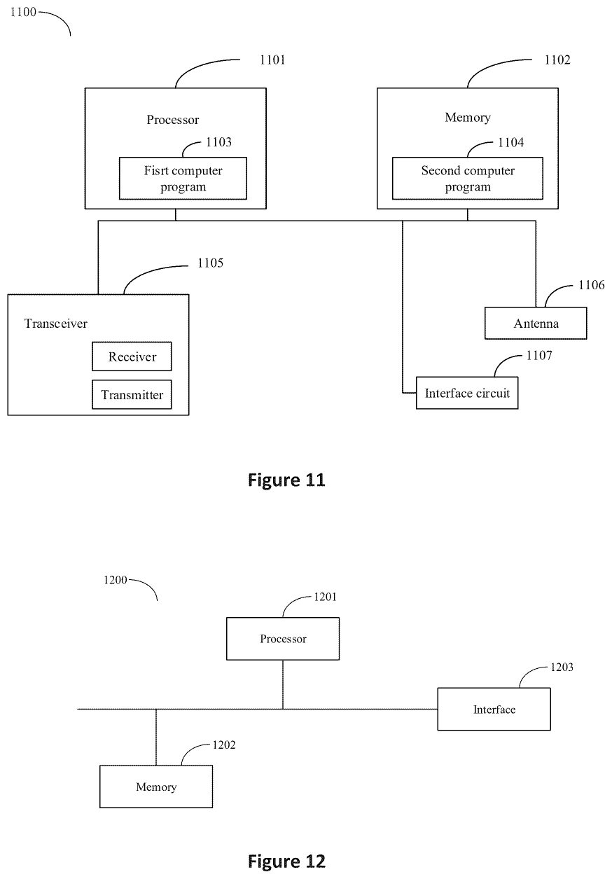

Reference is made to FIG. 11. FIG. 11 is a schematic structural diagram of a communication device 1100 according to another embodiment of the present disclosure. The communication device 1100 may be a network device or a terminal device, may also be a chip, a chip system, a processor or the like supporting the network device to implement the above method, and may also be a chip, a chip system, a processor or the like supporting the terminal device to implement the above method. The device may be configured to implement the method described in the above method embodiment, which may refer to the description in the above method embodiment in detail.

The communication device 1100 may include one or more processors 1101. The processor 1101 may be a general-purpose processor, a special-purpose processor or the like. For example, the processor may be a baseband processor or a central processing unit. The baseband processor may be configured to process a communication protocol and communication data. The central processing unit may be configured to control the communication device (such as a base station, a baseband chip, a terminal device, a terminal device chip, a DU, a CU or the like) to execute a computer program and process data of the computer program.

Optionally, the communication device 1100 may further include one or more memories 1102 which may store a second computer program 1104. The processor 1101 executes the second computer program 1104 to cause the communication device 1100 to perform the method described in the above method embodiments. Optionally, the memory 1102 may further store data. The communication device 1100 and the memory 1102 may be independently arranged or integrated.

Optionally, the communication device 1100 may further include a transceiver 1105 and an antenna 1106. The transceiver 1105 may be referred as to a transceiving unit, a transmitter receiver, a transceiver circuit or the like, which is configured to implement a transceiving function. The transceiver 1105 may include a receiver and a transmitter. The receiver may be referred as to a receiver, a receiving circuit or the like, which is configured to implement a receiving function; and the transmitter may be referred as to a transmitter, a transmission circuit or the like, which is configured to implement a transmitting function.

Optionally, the communication device 1100 may further include one or more interface circuits 1107. The interface circuit 1107 is configured to receive code instructions and transmit the code instructions to the processor 1101. The processor 1101 runs the code instructions to cause the communication device 1100 to perform the method described in the method embodiments.

In a case where the communication device 1100 is a terminal device, the processor 1101 is configured to perform step 301, step 302 and step 303 in FIG. 3; step 401, step 402 and step 403 in FIG. 4; step 501, step 502 and step 503 in FIG. 5; step 601, step 602 and step 603 in FIG. 6; and step 702 in FIG. 7, etc.

In a case where the communication device 1100 is a network device, the transceiver 1105 is configured to perform step 801 in FIG. 8 and step 901, step 902 in FIG. 9, etc.

In an embodiment, the processor 1101 may include a transceiver configured to implement receiving and transmitting functions. For example, the transceiver may be a transceiver circuit, an interface or an interface circuit. The transceiver circuit, the interface or the interface circuit configured to implement the receiving and transmitting functions may be separated or integrated. The above transceiver circuit, interface or interface circuit may be configured to read and write codes/data, or the above transceiver circuit, interface or interface circuit may be configured to transmit or transfer signals.

In an embodiment, the processor 1101 may store a first computer program 1103, and the first computer program 1103 runs on the processor 1101 to cause the communication device 1100 to perform the method described in the above method embodiments. The first computer program 1103 may be firmed in the processor 1101, and in this case, the processor 1101 may be implemented by hardware.

In an embodiment, the communication device 1100 may include a circuit. The circuit may implement the transmitting, receiving or communication function in the above method embodiments. The processor and the transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and the transceiver may also be manufactured by various IC technologies, for example, a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), a silicon germanium (SiGe), gallium arsenide (GaAs), etc.

The communication device described in the above embodiment may be the network device or an access device (such as the terminal device in the above method embodiments). However, the scope of the communication device described in the present disclosure is not limited to the embodiments here, and the structure of the communication device may not be limited by FIG. 11. The communication device may be an independent device or a part of a larger device. For example, the communication device may be:
(1) an independent integrated circuit (IC), chip, chip system or sub-system;
(2) a set with one or more ICs, optionally, the IC set may also include a storage component configured to store data and a computer program;
(3) an ASIC, for example, a modem;
(4) a module capable of being embedded into another device;
(5) a receiver, a terminal device, a smart terminal device, a cell phone, a wireless device, a handset, a mobile unit, a vehicle-mounted device, a network device, a cloud device, an artificial intelligence device or the like; and
(6) others.

A case where the communication device may be the chip or the chip system may refer to a schematic structural diagram of a chip shown in FIG. 12. The chip shown in FIG. 12 includes a processor 1201 and an interface 1203. There may be one or more processors 1201 and a plurality of interfaces 1203.

In a case where the chip is configured to implement the functions of the terminal device according to the embodiments of the present disclosure:
the interface 1203 is configured to perform step 201 and step 202 in FIG. 2; step 304 and step 305 in FIG. 3; step 404 and step 405 in FIG. 4; step 504 and step 505 in FIG. 5; step 604 and step 605 in FIG. 6; step 701, step 703 and step 704 in FIG. 7, etc.

In a case where the chip is configured to implement the functions of the network device according to the embodiments of the present disclosure:
the interface 1203 is configured to perform step 801 in FIG. 8; step 901 and step 902 in FIG. 9, etc.

Optionally, the chip further includes a memory 1203, and the memory 1203 is configured to store necessary computer programs and data.

Those skilled in the art may also understand that various illustrative logical blocks and steps listed in the examples of the present disclosure may be implemented by electronic hardware, computer software or combining both. Whether such functions are implemented by the hardware or the software depends on a specific application and a design demand of a whole system. Those skilled in the art may use various methods for implementing the functions for each specific application, but such embodiment is not construed as departing from the protection scope of the example of the present disclosure.

A readable storage medium storing instructions is further provided according to the present disclosure, where the instructions, when executed by a computer, implement functions in any above method embodiments.

A computer program product is further provided according to the present disclosure, where the computer program product, when executed by a computer, implements functions in any above method embodiments.

The above embodiments may be implemented entirely or partially through software, hardware, firmware or any combination of them. An implementation by the software may be entirely or partially in a form of a computer program product. The computer program product includes one or more computer programs. When the computer programs are loaded and executed on the computer, all or a part of flows or functions according to the embodiment of the present disclosure are generated. The computer may be a general-purpose computer, a special-purpose computer, a computer network, or other programmable devices. The computer program may be stored in a computer-readable storage medium, or transmitted from one computer-readable storage medium to another computer-readable storage medium, for example, the computer program may be transmitted from one website, computer, server or data center to another website, computer, server or data center in a wired mode (for example, a coaxial cable, an optical fiber, a digital subscriber line (DSL)) or wireless mode (for example, infrared, wireless, microwave or the like). The computer-readable storage medium may be any available medium that the computer can access, or a server, a data center and another data storage device including one or more available media integrated. The available medium may be a magnetic medium (for example, a floppy disk, a hard disk and a magnetic tape), an optical medium (for example, a high-density digital video disc (DVD)), or a semiconductor medium (for example, a solid state disk (SSD)), etc.

It should be understood that “a plurality of” in the present disclosure refers to two or more than two, and the other quantifiers are similar to this. “And/or” describes an association relationship between associated objects and represents that there may be three relationships. For example, A and/or B, which represents that merely A exists, both A and B exist, and merely B exists. A character “/” generally represents an “or” relationship between associated objects before and after the character. A singular form “a/an”, “the” and “said” intends to include a plural form unless other meanings are indicated clearly in the context.

It may be further understood that the operations in the examples of the present disclosure are described in a specific sequence in the accompanying drawings, but it is not understood as requiring to execute these operations in the specific sequence or a serial sequence as shown, or requiring to execute all the shown operations to achieve an expected result. In a specific environment, multi-task and parallel processing are possibly beneficial.

Those ordinarily skilled in the art can understand that various ordinal numerals such as first and second involved in the present disclosure are distinguished for convenient description only, which are not used to limit the scope of the embodiments of the present disclosure and also represent a sequential order.

The term “at least one” in the present disclosure may also be described as one or more, and more may be two, three, four or more, which is not limited in the present disclosure. In the embodiments of the present disclosure, for a technical feature, technical features are distinguished through “first”, “second”, “third”, “A”, “B”, “C”, “D” and the like, and there is no sequential order or magnitude sequence between the technical features described by “first”, “second”, “third”, “A”, “B”, “C” and “D”.

A correspondence relationship shown in each table in the present disclosure may be configured or pre-defined. Values of information in each table are merely examples and may be set as other values, which are not limited in the present disclosure. During configuring the correspondence relationship between information and various parameters, it is not necessary to configure all the corresponding relationships shown in each table. For example, in the tables of the present disclosure, the correspondence relationships shown in some rows may also be not configured. For another example, an appropriate variation may be made based on the above tables, for example, splitting, merging and the like. Names of parameters shown in titles in each table may also use other names comprehensible for the communication device, and values or representation forms of the parameters may also be other values or representation forms comprehensible for the communication device. In an embodiment of each above table, other data structures may also be used, for example, an array, a queue, a container, a stack, a linear table, a pointer, a chain table, a tree, a graph, a structural body, a class, a heap, a hash table, or the like may be used.

Pre-defining in the present disclosure may be understood as defining, pre-defining, storage, pre-storage, pre-consulting, pre-configuration, firming or pre-flash.

Those ordinarily skilled in the art may realize that units and algorithm steps of the various examples described with reference to the examples disclosed here can be implemented by electronic hardware or combining computer software and the electronic hardware. Whether these functions are performed in a form of hardware or a form of software depends on particular applications and design constraint conditions of the technical solutions. Professionals may use different methods for implementing the described functions for each particular application, which is not to be regarded as departing from the scope of the present disclosure.

Those skilled in the art may clearly understand that specific operating processes of the above described system, devices and units may refer to corresponding processes in the above method example for convenient and concise description, which are not repeated here.

Those skilled in the art would readily conceive other implementations of the embodiments of the present disclosure upon consideration of the specification and practice of the present disclosure here. The present disclosure is intended to cover any variations, uses, or adaptations of the embodiments of the present disclosure. These variations, uses, or adaptations comply with the general principles of the embodiments of the present disclosure, and include common knowledge or technical means in the art which are not disclosed here. The specification and embodiments are to be considered as illustrative merely, the scope and spirit of the embodiments of the present disclosure are defined by the following claims.

The above is merely specific embodiments of the present disclosure, which does not limit the protection scope of the present disclosure. Any of those skilled in the art can easily conceive variations or replacements within the technical scope disclosed by the present disclosure. Such variations or replacements are included within the protection scope of the present disclosure. Hence, the protection scope of the present disclosure is defined by the claims.

1. A method for reporting position information, performed by a terminal device, comprising:
determining that a timing advance (TA) variation value corresponding to the terminal device is greater than a threshold value, wherein the TA variation value is caused by a change in a position of the terminal device; and
reporting position information of the terminal device to a network device.

2. The method according to claim 1, further comprising:
determining a first TA value according to first position information corresponding to the terminal device at a current moment and second position information corresponding to a satellite at the current moment;
determining a second TA value according to third position information last reported by the terminal device and the second position information; and
determining the TA variation value according to a difference value between the first TA value and the second TA value.

3. The method according to claim 1, further comprising:
determining a first TA compensation value according to first position information corresponding to the terminal device at a current moment and second position information corresponding to a satellite at the current moment;
determining a second TA compensation value according to third position information last reported by the terminal device and the second position information; and
determining the TA variation value according to a difference value between the first TA compensation value and the second TA compensation value.

4. The method according to claim 1, further comprising:
determining a third TA value according to first position information corresponding to the terminal device at a current moment and fourth position information corresponding to a satellite when the position information was last reported;
determining a fourth TA value according to third position information last reported by the terminal device and the fourth position information; and
determining the TA variation value according to a difference value between the third TA value and the fourth TA value.

5. The method according to claim 1, further comprising:
determining a third TA compensation value according to first position information corresponding to the terminal device at a current moment and fourth position information corresponding to a satellite when the position information was last reported;
determining a fourth TA compensation value according to third position information last reported by the terminal device and the fourth position information; and
determining the TA variation value according to a difference value between the third TA compensation value and the fourth TA compensation value.

6. The method according to claim 1, further comprising:
receiving indication information sent by the network device, wherein the indication information is configured to indicate configuration information for the terminal device to report the position information.

7. The method according to claim 6, wherein the configuration information comprises any one of description information of the TA variation value, a periodic value for reporting the position information, and TA reporting configuration information based on a media access control control element (MAC CE).

8. A method for reporting position information, performed by a network device, comprising:
receiving position information of a terminal device reported by the terminal device, wherein the position information is sent by the terminal device in a case where the terminal device determines that a timing advance (TA) variation value caused by a change in a position of the terminal device is greater than a threshold value.

9. The method according to claim 8, further comprising:
sending indication information to the terminal device, wherein the indication information is configured to indicate configuration information for the terminal device to report the position information.

10. The method according to claim 9, wherein the configuration information comprises any one of description information of the TA variation value, a periodic value of reporting the position information, and TA reporting configuration information based on a media access control control element (MAC CE).

11-20. (canceled)

21. A communication device, comprising:
one or more processors; and a memory that stores a computer program, wherein the one or more processors are configured to execute the computer program stored on the memory to cause the communication device to perform a method for reporting position information,
wherein the method comprises:
determining that a timing advance (TA) variation value corresponding to a terminal device is greater than a threshold value, wherein the TA variation value is caused by a change in a position of the terminal device; and
reporting position information of the terminal device to a network device.

22. A communication device, comprising:
one or more processors; and
a memory that stores a computer program, wherein
the one or more processors are configured to execute the computer program stored on the memory to cause the communication device to perform the method for reporting position information according to claim 8.

23. A non-transitory computer-readable storage medium, configured to store instructions, wherein the instructions, when executed, implement the method for reporting position information according to claim 1.

24. A non-transitory computer-readable storage medium, configured to store instructions, wherein the instructions, when executed, implement the method for reporting position information according to claim 8.

25. The communication device according to claim 21, wherein
the method further comprises:
determining a first TA value according to first position information corresponding to the terminal device at a current moment and second position information corresponding to a satellite at the current moment;
determining a second TA value according to third position information last reported by the terminal device and the second position information; and
determining the TA variation value according to a difference value between the first TA value and the second TA value; or
the method further comprises:
determining a first TA compensation value according to first position information corresponding to the terminal device at a current moment and second position information corresponding to a satellite at the current moment;
determining a second TA compensation value according to third position information last reported by the terminal device and the second position information; and
determining the TA variation value according to a difference value between the first TA compensation value and the second TA compensation value; or
the method further comprises:
determining a third TA value according to first position information corresponding to the terminal device at a current moment and fourth position information corresponding to a satellite when the position information was last reported;
determining a fourth TA value according to third position information last reported by the terminal device and the fourth position information; and
determining the TA variation value according to a difference value between the third TA value and the fourth TA value.

26. The communication device according to claim 21, wherein the method further comprises:
determining a third TA compensation value according to first position information corresponding to the terminal device at a current moment and fourth position information corresponding to a satellite when the position information was last reported;
determining a fourth TA compensation value according to third position information last reported by the terminal device and the fourth position information; and
determining the TA variation value according to a difference value between the third TA compensation value and the fourth TA compensation value.

27. The communication device according to claim 21, wherein the method further comprises:
receiving indication information sent by the network device, wherein the indication information is configured to indicate configuration information for the terminal device to report the position information.

28. The communication device according to claim 27, wherein the configuration information comprises any one of description information of the TA variation value, a periodic value for reporting the position information, and TA reporting configuration information based on a media access control control element (MAC CE).

29. The communication device according to claim 22, wherein the method further comprises:
sending indication information to the terminal device, wherein the indication information is configured to indicate configuration information for the terminal device to report the position information.

30. The communication device according to claim 29, wherein the configuration information comprises any one of description information of the TA variation value, a periodic value of reporting the position information, and TA reporting configuration information based on a media access control control element (MAC CE).
